(19) United States
(12) Patent Application Publication
(10) Pub. No.: US 2023/0356284 A1
(43) Pub. Date: Nov. 9, 2023

(54) Process of making an eccentric threaded fastener

(71) Applicant: Wen-Pin Huang, Kaohsiung (TW)

(72) Inventor: Wen-Pin Huang, Kaohsiung (TW)

(21) Appl. No.: 18/224,573

(22) Filed: Jul. 21, 2023

(51) Int. Cl. B21D 53/24; F16B 39/12

(52) U.S. Cl. CPC B21D 53/24; F16B 39/128

(57) ABSTRACT

A manufacturing process includes drilling a hole through a polyhedron; cutting a first surface from an outer surface of the polyhedron to the hole and subsequently clockwise cutting the outer surface of the polyhedron until the cutting meets a bottom edge of the first surface to form first and second nuts; rotating the first nut with about the second nut along the spiral cut surface to separate the first nut from the second nut, thereby forming a second surface, increasing height of the polyhedron, and forming a gap from the first surface to the second surface between the first nut and the second nut; fastening the first and second nuts together by spot welding; and disposing a sleeve on the polyhedron and driving a tap through the axial hole to create female threads in the first and second nuts respectively. An eccentric, internally threaded fastener is finished.

### BACKGROUND OF THE INVENTION

### 1. Field of the Invention

The invention relates to processes of manufacturing threaded fasteners and more particularly to a process of manufacturing an eccentric, internally threaded fastener having surfaces with increased friction.

### 2. Description of Related Art

Typically, a workpiece fastened by a screw or bolt and nut combination will not become loose in a static state. However, the workpiece may loosen if the workpiece is in a vibrational environment for a long time because the vibration may be transferred to the screw or bolt and nut combination and loosen the screw or bolt and nut combination.

Thus, the need for improvement still exists.

### SUMMARY OF THE INVENTION

It is therefore one object of the invention to provide a process of manufacturing an eccentric, internally threaded fastener, comprising the steps of drilling an axial hole having a circular section through a polyhedron; upward cutting a first surface from an intermediate portion of an outer surface of the polyhedron to the axial hole and subsequently clockwise cutting the outer surface of the polyhedron until the cutting meets a bottom edge of the first surface to form a first nut and a second nut so that the cut surface except the first surface is spiral; rotating the first nut with respect to the second nut along the spiral cut surface to separate the first nut from the second nut, thereby forming a second surface, increasing height of the polyhedron, and forming a gap from the first surface to the second surface between the first nut and the second nut; welding a plurality of welding points along a joining line of the first nut and the second nut, thereby fastening the first nut and the second nut together to form an eccentric fastener; and disposing a sleeve on the polyhedron and driving a tap through the axial hole to create female threads in the first nut and female threads in the second nut respectively so that the eccentric fastener is internally threaded.

The above and other objects, features and advantages of the invention will become apparent from the following detailed description taken with the accompanying drawings.

### BRIEF DESCRIPTION OF THE DRAWINGS

FIG. 1 is a flow chart of a process of manufacturing an eccentric, internally threaded fastener according to the invention;

FIG. 2 is a perspective view schematically depicting the forming step A;

FIG. 3 is a perspective view schematically depicting the cutting step B;

FIG. 4 is a perspective view schematically depicting a result of the cutting step B;

FIG. 5 is a perspective view schematically depicting the opening step C;

FIG. 6 is a perspective view schematically depicting a result of the opening step C;

FIG. 7 is a perspective view schematically depicting the spot welding step D;

FIG. 8 schematically depicts the threading step E;

FIG. 9 is a side elevation in part section schematically depicting an installation step;

FIG. 10 is a perspective view schematically depicting the gap being decreased in the installation step;

FIG. 11 is a perspective view schematically depicting a result in FIG. 10;

FIG. 12 is a perspective view schematically depicting details in a lower part of FIG. 9;

FIG. 13 is a perspective view of the first nut; and

FIG. 14 is a perspective view of the second nut.

### DETAILED DESCRIPTION OF THE INVENTION

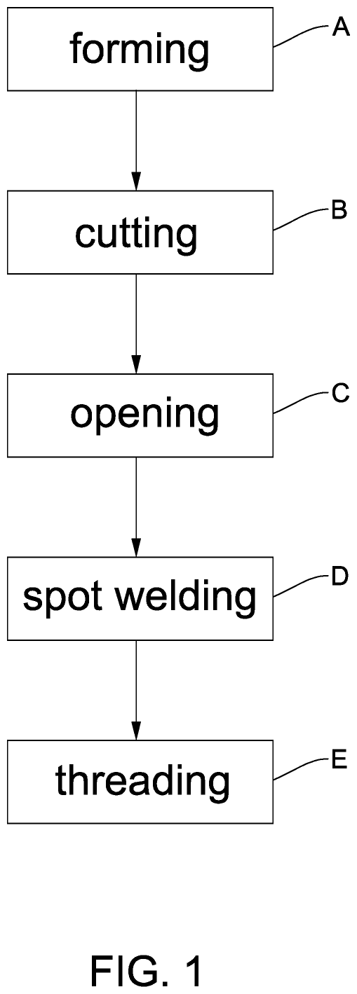

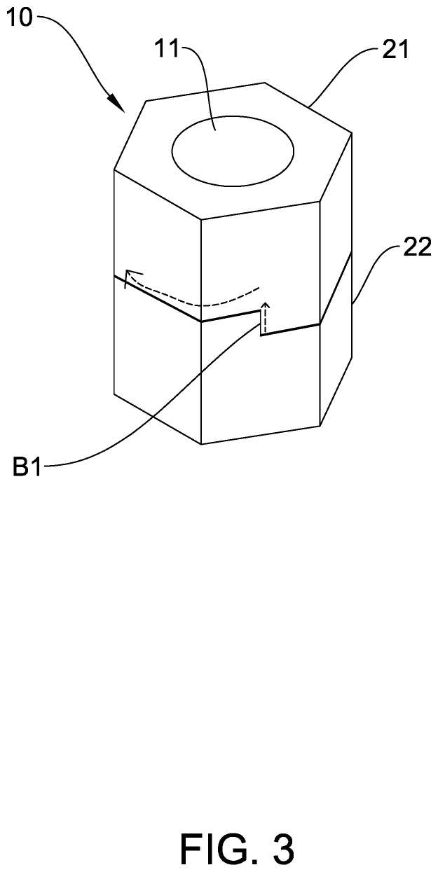

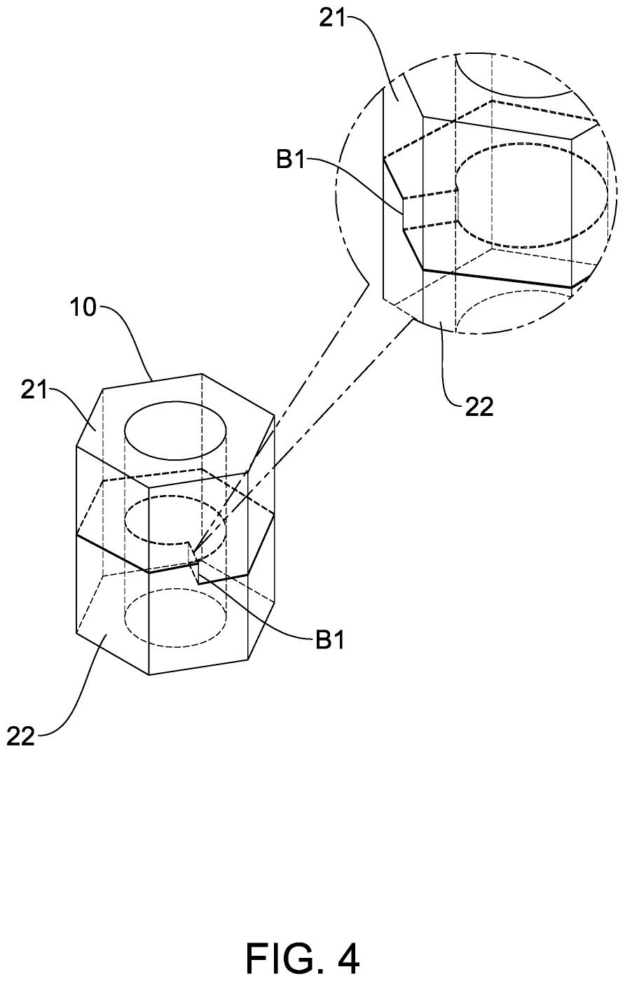

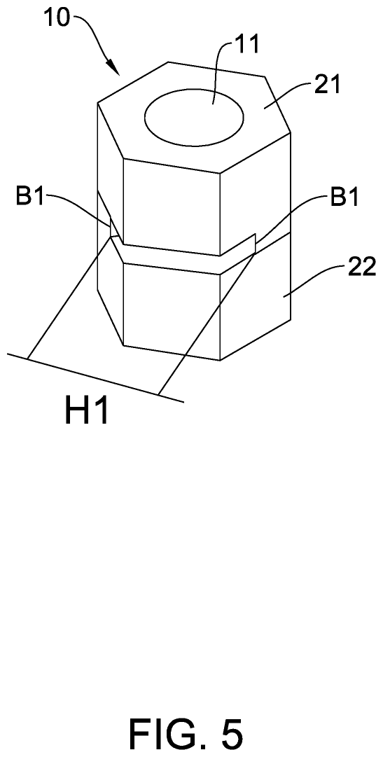

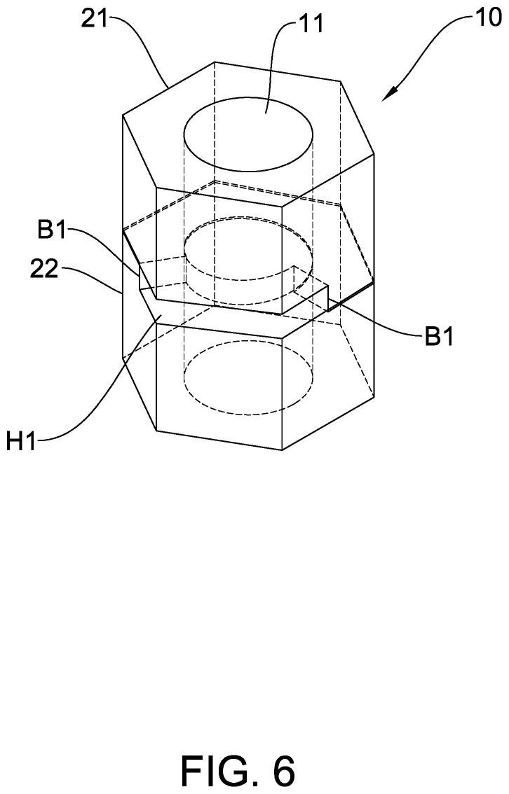

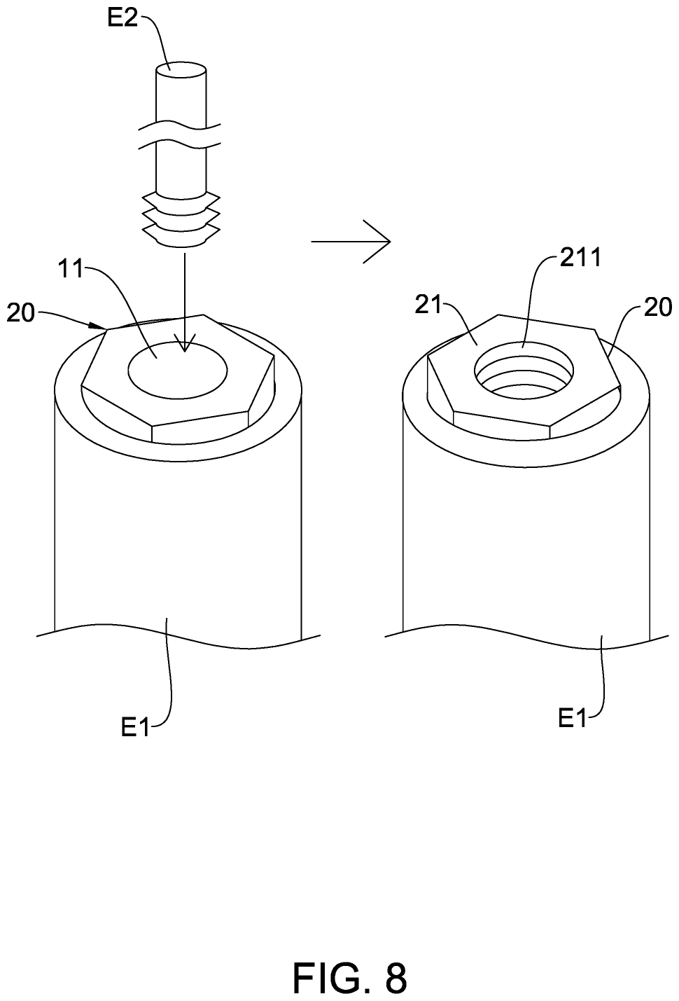

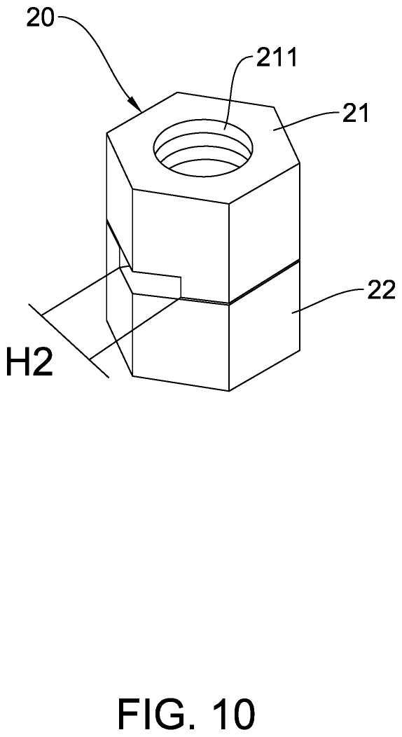

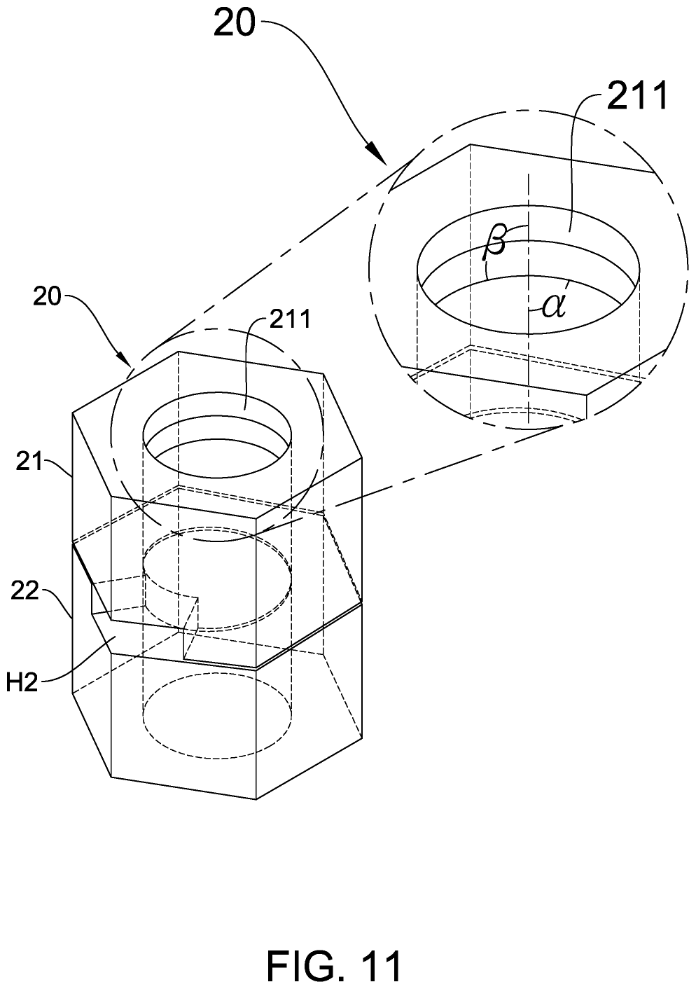

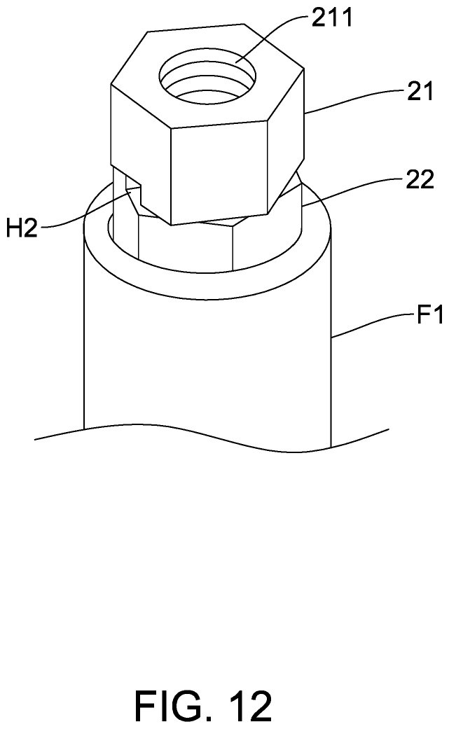

Referring to FIGS. 1 to 14, a process of manufacturing an eccentric, internally threaded fastener and installing same in accordance with the invention is illustrated and comprises the following steps as detailed below.

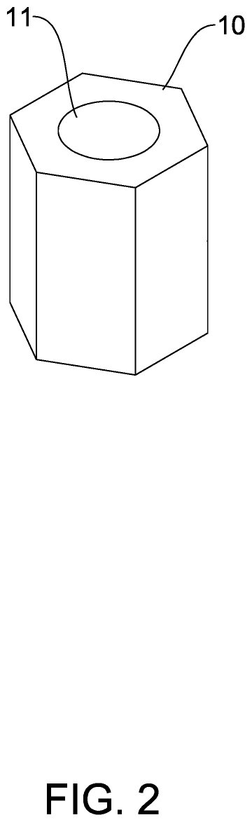

As illustrated in FIGS. 1 and 2 specifically, step A of forming includes drilling an axial hole 11 having a circular section through a polyhedron (e.g., hexagon) 10 and a diameter of the axial hole 11 is about equal to that of a threaded shank of a screw.

As illustrated in FIGS. 1, 3 and 4 specifically, step B of cutting includes upward cutting a surface B1 from an intermediate portion of an outer surface of the polyhedron 10 to the axial hole 11 and subsequently clockwise cutting the outer surface of the polyhedron 10 until the cutting meets a bottom edge of the surface B1 to form a first nut 21 and a second nut 22. That is, the cut surface except the surface B1 is spiral.

As illustrated in FIGS. 1, 5 and 6 specifically, step C of opening includes rotating the first nut 21 with respect to the second nut 22 along the spiral cut surface to separate the first nut 21 from the second nut 22. As a result, the other surface B1 is formed, height of the polyhedron 10 is increased and a gap H1 from one surface B1 to the other surface B1 is formed between the first nut 21 and the second nut 22.

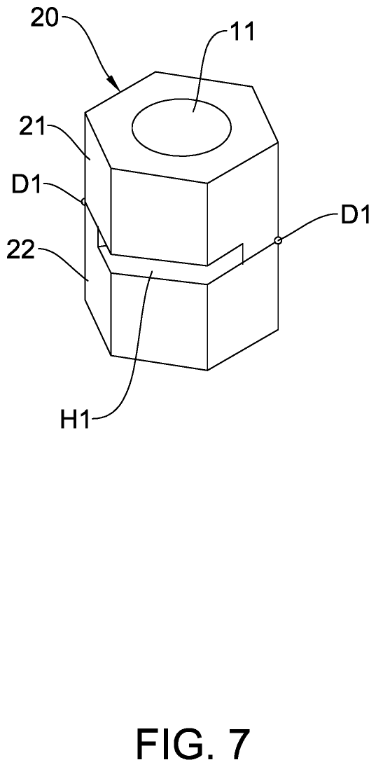

As illustrated in FIGS. 1 and 7 specifically, step D of spot welding includes welding a plurality of welding points D1 along a joining line of the first nut 21 and the second nut 22, thereby fastening the first nut 21 and the second nut 22 together to form an eccentric fastener 20.

As illustrated in FIGS. 1, 8, 13 and 14 specifically, step E of threading includes disposing a sleeve E1 on the polyhedron 10 and driving a tap E2 through the axial hole 11 to create female threads 211 in the first nut 21 and female threads 221 in the second nut 22 respectively. As a result, the eccentric fastener 20 is internally threaded.

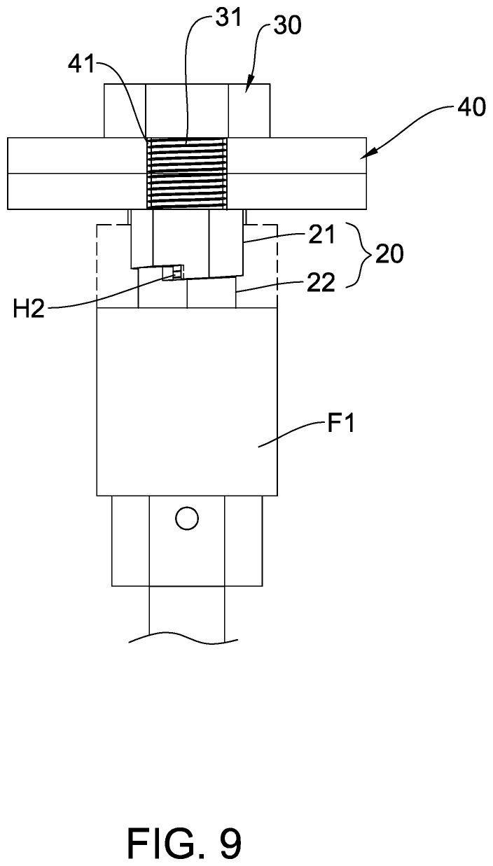

As illustrated in FIGS. 9, 13 and 14 specifically, there is further provided with an installation step including driving a threaded shank 31 of a bolt 30 through a hole 41 of a workpiece 40 into the female threads 211, 221 until a top of the first nut 21 is pressed by the workpiece 40.

As illustrated in FIGS. 1, 10, 11 and 12 specifically, a wrenching tool F1 is disposed on the second nut 22 to hold it and is used to counterclockwise rotate the second nut 22 in order to break the welding points D1 and increase stress of the eccentric threaded fastener 20. A gap H2 between the first nut 21 and the second nut 22 is gradually decreased. Also, the spiral cut surface applies an eccentric force on the eccentric threaded fastener 20, resulting in an lead angle α between the threaded shank 31 and the eccentric threaded fastener 20 to be greater than a helix angle β between the threaded shank 31 and the eccentric threaded fastener 20. As a result, the eccentric threaded fastener 20 produces an effect of preventing the fastened workpiece 40 from loosening.

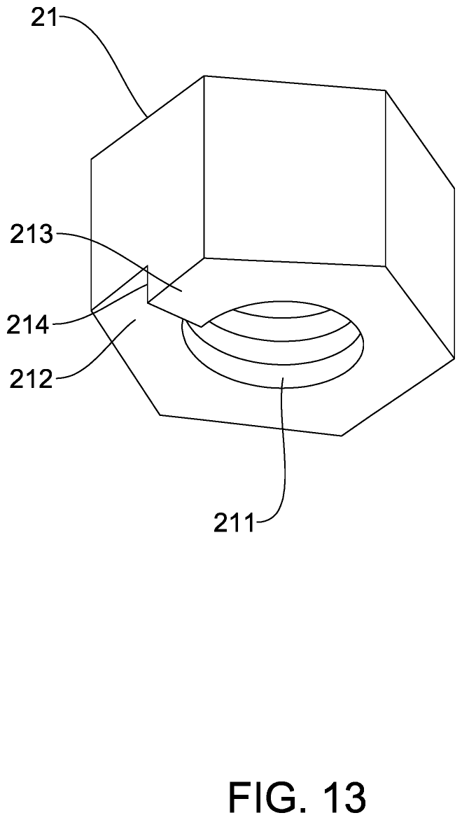

As illustrated in FIG. 13 specifically, the first nut 21 includes a threaded hole 211 for fitting around and securing to the threaded shank 31, an eccentric surface 212 adjacent to the threaded hole 211, a frictional surface 213 spirally extending out of one end of the eccentric surface 1412 to the other end thereof, and a shoulder 214 interconnecting the eccentric surface 212 and the frictional surface 213.

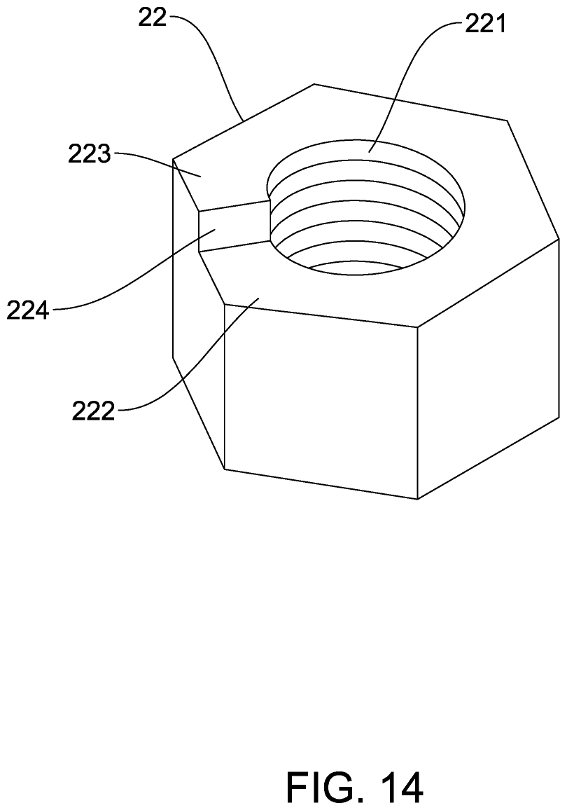

As illustrated in FIG. 14 specifically, the second nut 22 includes a threaded hole 221 for fitting around and securing to the threaded shank 31, an eccentric surface 222 adjacent to the threaded hole 221, a frictional surface 223 spirally extending out of one end of the eccentric surface 1412 to the other end thereof, and a shoulder 224 interconnecting the eccentric surface 222 and the frictional surface 223.

As illustrated in FIGS. 9, 10 and 11 specifically, the wrenching tool F1 is used to counterclockwise rotate the second nut 22 in order to break the welding points D1. The second nut 22 spirally lifts along the eccentric surface 212 and frictional surface 213 to secure to the first nut 21. Also, an eccentric force is generated by the eccentric surface 212, the frictional surface 223, the eccentric surface 222, and the frictional surface 223, thereby fastening the first nut 21 and the second nut 22 together. As a result, the eccentric threaded fastener 20 produces an effect of anti-loose. Further, the gap H2 between the first nut 21 and the second nut 22 is gradually decreased. Also, the spiral cut surface applies an eccentric force on the eccentric threaded fastener 20, resulting in the lead angle between the threaded shank 31 and the eccentric threaded fastener 20 to be greater than the helix angle between the threaded shank 31 and the eccentric threaded fastener 20. As a result, the eccentric threaded fastener 20 produces an effect of anti-loose.

While the invention has been described in terms of preferred embodiments, those skilled in the art will recognize that the invention can be practiced with modifications within the spirit and scope of the appended claims.

What is claimed is:

1. A process of manufacturing an eccentric, internally threaded fastener, comprising the steps of:
(a) drilling an axial hole having a circular section through a polyhedron;
(b) upward cutting a first surface from an intermediate portion of an outer surface of the polyhedron to the axial hole and subsequently clockwise cutting the outer surface of the polyhedron until the cutting meets a bottom edge of the first surface to form a first nut and a second nut so that the cut surface except the first surface is spiral;
(c) rotating the first nut with respect to the second nut along the spiral cut surface to separate the first nut from the second nut, thereby forming a second surface, increasing height of the polyhedron, and forming a gap from the first surface to the second surface between the first nut and the second nut;
(d) welding a plurality of welding points along a joining line of the first nut and the second nut, thereby fastening the first nut and the second nut together to form an eccentric fastener; and
(e) disposing a sleeve on the polyhedron and driving a tap through the axial hole to create female threads in the first nut and female threads in the second nut respectively so that the eccentric fastener is internally threaded.

2. The process of claim 1, wherein each of the first and second nuts include a threaded hole, an eccentric surface adjacent to the threaded hole, a frictional surface spirally extending out of a first end of the eccentric surface to a second end thereof, and a shoulder interconnecting the eccentric surface and the frictional surface.
